(19) United States
(12) Patent Application Publication
(10) Pub. No.: US 2026/0320831 A1
(43) Pub. Date: Oct. 15, 2026

(54) SYSTEMS AND METHODS FOR CALIBRATING CAMERAS AND CAMERA ARRAYS

(71) Applicant: Visionary Machines Pty Ltd, Sydney, New South Wales (AU)

(72) Inventor: Rhys Andrew NEWMAN, Sydney (AU)

(21) Appl. No.: 19/150,702

(22) PCT Filed: Jan. 18, 2024
(86) PCT No.: PCT/AU2024/050025

§ 371 Date: Jul. 24, 2025

(30) Foreign Application Priority Data
Jan. 24, 2023 (AU) 2023900170

(51) Int. Cl. G06T 7/80; G06T 7/73; H04N 17/00

(52) U.S. Cl. CPC G06T 7/80; G06T 7/73; H04N 17/002

(57) ABSTRACT

The present disclosure is directed to devices, systems and/or methods that may be used for calibrating at least one camera by letting the camera view a suitably constructed calibration scene that contains calibration points arranged in a manner that supports accuracy with limited demands on the number and physical 3D location accuracy of the calibration points.

### FIELD

The present disclosure relates generally to devices, systems and/or methods that may be used for calibrating cameras and/or camera arrays.

### BACKGROUND

Cameras and arrays of cameras are useful in many applications including, for example, the safe autonomous driving of vehicles, and for example for navigation, surveying, environmental monitoring, crop monitoring, mine surveying, and checking the integrity of built structures. Cameras and camera arrays commonly require calibration before they may be used to compute quantitative positions and other measurements of the 3D scene in view. The calibration approach disclosed herein is an improved procedure for determining a relationship between the position on the camera image plane (i.e., typically measured in pixels) and a straight ray/line along which light from the surfaces and objects in the scene passes in order to register on the camera imaging sensor at that (pixel) position. The use of a pinhole camera model is known in the art. When using the pinhole camera model, the rays of light emanating from a source or surface in the physical world in view (i.e., the scene) are considered to pass unimpeded along a straight line, through a fixed plane in space that represents the camera's image sensor (otherwise known in the art as the camera's imaging plane), and terminate at a single 3D point known in the art as the “camera centre”. More complex approaches that account for known lens distortions are also known in the art, but these may be considered as refinements of the pinhole model. Irrespective of the camera approach (pinhole or more complex), the image formation process is a physical projection of light rays travelling across the scene from their source in straight lines towards the camera and associated lenses, which are then detected by some detection mechanism (e.g., a chemical film for older cameras, or photon-sensitive electronics in the case of a digital camera sensor).

However, the precise paths these rays take, and even the position of the camera centre in 3D space, are typically not known with sufficient precision from the camera manufacturer alone. Further, as the imaging process also depends on the relative position of the camera to the origin of the frame of reference from which 3D measurements and positions are made (often an arbitrary choice depending on the use case) the relationship between a light ray's path across the scene and the position of its eventual detection on the camera sensor are not generally knowable in advance of the camera or camera array installation.

Consequently, camera systems typically require a procedure to determine this relationship once installed in their intended operational position. This process or set of procedures is often referred to as “camera calibration”. There are various ways of camera calibration known in the art, each assuming a different set of known facts about a scene or scenes and requiring different known elements to be present in one or more images captured by the camera or cameras. However, each technique carries with it certain compromises between convenience (i.e., the number of frames and the size and complexity of the calibration scene required to be imaged during the procedure) and accuracy (i.e., the precision with which rays from locations in the 3D scene are determined from their position in the image formed with the camera).

The present disclosure is directed to calibrating cameras and camera arrays. The present disclosure also is directed to overcome and/or ameliorate at least one or more of the disadvantages of the prior art, as will become apparent from the discussion herein. The present disclosure also provides other advantages and/or improvements as discussed herein.

### SUMMARY

This summary is not intended to be limiting as to the embodiments disclosed herein and other embodiments are disclosed in this specification. In addition, limitations of one embodiment may be combined with limitations of other embodiments to form additional embodiments.

Certain embodiments are directed to systems or methods for calibrating a camera wherein the camera is configured to image a configured calibration scene, and the configured scene contains at least a three-dimensional region of interest and a number of visible calibration points at known three-dimensional locations.

Certain embodiments are directed to systems or methods for calibrating a camera wherein the camera is configured to image a configured calibration scene, and the configured scene contains at least a three-dimensional region of interest, and a number of visible calibration points at known three-dimensional locations, wherein a portion of the number of visible calibration points are neither co-planar nor co-linear (in three dimensions).

At least one embodiment is to a system for calibrating a camera comprising:
at least one camera;
wherein the camera is configured to image a configured calibration scene and the configured scene contains a least a three-dimensional region of interest and a number of visible calibration points at known three-dimensional locations which are arranged in the three-dimensional region of interest with a minimum separation between a substantial portion of pairs of calibration points in the three-dimensional region, and the enclosing volume of the number of visible calibration points is at least a substantial portion of the total volume of the region of interest;
one or more processors that is configured to:
capture at least one image from the at least one camera and receive visible location of a number of calibration points at known three-dimensional locations; and
use the locations in the image of the visible calibration points together with their known three-dimensional locations to calculate a camera calibration.

At least one embodiment is to a system for calibrating a camera comprising:
at least one camera;
wherein the camera is configured to image a configured calibration scene and the configured scene contains a least a three-dimensional region of interest and a number of visible calibration points at known three-dimensional locations which are arranged in the three-dimensional region of interest with a minimum separation between a substantial portion of pairs of calibration points in the three-dimensional region, and the enclosing volume of the number of visible calibration points is at least a substantial portion of the total volume of the region of interest;
one or more processors that is configured to:
capture at least one image from the at least one camera and receive visible location of a number of calibration points at known three-dimensional locations; and
use the locations in the image of the visible calibration points together with their known three-dimensional locations to calculate a camera calibration.

At least one embodiment is to a method for calibrating a camera comprising:
configuring a calibration scene, wherein the configured scene contains a least a three-dimensional region of interest and a number of visible calibration points, visible to that at least one camera, at known three-dimensional locations which are arranged in the three-dimensional region of interest with a minimum separation between a substantial portion of pairs of calibration points in the three-dimensional region of at least 10% of the total depth of the region of interest;
placing at least one camera to view the calibration scene, wherein the camera is configured to image the number of visible calibration points;
taking an image of the number of the number of visible calibration points;
transferring the image to the one or more processes; and
   using the one or more processors to determine the locations in the image of the visible calibration points together with their known three-dimensional locations to calculate a camera calibration.

At least one embodiment is to a method for calibrating a camera comprising:
configuring a calibration scene, wherein the configured scene contains a least a three-dimensional region of interest and a number of visible calibration points, visible to that at least one camera, at known three-dimensional locations which are arranged in the three-dimensional region of interest with a minimum separation between a substantial portion of pairs of calibration points in the three-dimensional region of at least 10% of the total depth of the region of interest;
placing at least one camera to view the calibration scene, wherein the camera is configured to image the number of visible calibration points;
taking an image of the number of the number of visible calibration points;
transferring the image to the one or more processes; and
using the one or more processors to determine the locations in the image of the visible calibration points together with their known three-dimensional locations to calculate a camera calibration.

Certain embodiments are to devices, methods and/or systems comprising:
at least one camera sensor; wherein the sensor is configured to capture one or more images of a scene that contains within the camera's view a number of identifiable positions in 3D physical space, the 3D position of at least some of these positions is known to an acceptable level of accuracy. The system is further configured to receive the location of the 2D projection of at least one of these identifiable positions, which together with the associated known 3D location of the at least one identifiable position enables determination of the camera projection process (i.e., a camera calibration).

Certain embodiments are to method for determining a camera calibration using at least one of the system embodiments disclosed herein.

Certain embodiments are directed to one or more computer-readable non-transitory storage media embodying software that is operable when executed using any of the systems and/or methods disclosed herein.

### BRIEF DESCRIPTION OF DRAWINGS

FIG. 1 illustrates prior art of the image formation process and certain components of the pinhole camera model.

FIG. 2 shows an exemplary embodiment of a camera observing a scene with a number of calibration points at a range of known 3D locations.

FIG. 3 shows a representation of the process flow, according to at least one embodiment.

FIG. 4 shows how a standard “pinhole” camera model may be computed from the known locations of the calibration points in 3D and their respective projections onto the camera's image plane. This method is known as Direct Linear Transformation (DLT).

FIG. 5 shows the average 3D error of computing the 3D positions of the minimal 6 calibration points required by the standard DLT method plotted against increasing amounts of positional error in their projections on the image plane (X axis).

FIG. 6 shows the average 3D error of computing the 3D positions of various arrangements and numbers of calibration points plotted against increasing amounts of positional error in their projections on the image plane (X axis).

FIG. 7 shows additional average 3D error of computing the 3D positions of various arrangements and numbers of calibration points plotted against increasing amounts of positional error in their projections on the image plane (X axis).

FIG. 8 compares 2 plane calibration solutions with 3 plane calibration solutions. Over many experiments with various 2 and 3 plane arrangements, the 95th centile worst reconstruction errors are shown as a histogram.

FIG. 9 compares 3 plane versus 4 plane calibration solutions, with various numbers of calibration points on each plane.

FIG. 10 shows the best 95th centile value for a number of experiments using increasing numbers of calibration planes.

FIG. 11 shows the best 95th centile value for many experiments that trial increasing numbers of calibration points arranged around the region of interest with no 2 calibration points being closer than 10% of the depth of the region.

FIG. 12 illustrate exemplary non-limiting region of interest shapes with a camera array in front of the illustrated regions of interest.

### DETAILED DESCRIPTION

The following description is provided in relation to several embodiments that may share common characteristics and features. It is to be understood that one or more features of one embodiment may be combined with one or more features of other embodiments. In addition, a single feature or combination of features in certain of the embodiments may constitute additional embodiments. Specific structural and functional details disclosed herein are not to be interpreted as limiting, but merely as a representative basis for teaching one skilled in the art to variously employ the disclosed embodiments and variations of those embodiments.

The subject headings used in the detailed description are included only for the ease of reference of the reader and should not be used to limit the subject matter found throughout the disclosure or the claims. The subject headings should not be used in construing the scope of the claims or the claim limitations.

Certain embodiments of this disclosure may be useful in a number of areas. For example, one or more of the following non-limiting exemplary applications: off-road vehicle (e.g., cars, buses, motorcycles, trucks, tractors, forklifts, cranes, backhoes, bulldozers); road vehicles (e.g., cars, buses, motorcycles, trucks); rail based vehicles (e.g., locomotives); air based vehicles (e.g., airplanes, drones), space based vehicles (e.g., satellites, or constellations of satellites); individuals (e.g., miners, soldiers, war fighters, rescuers, maintenance workers), amphibious vehicles (e.g., boats, cars, buses); and watercraft (e.g., ships boats, hovercraft, submarines). In addition, the non-limiting exemplary applications may be operator driven, semi-autonomous and/or autonomous. Further applications may include navigation, autonomous vehicle navigation, surveying, surveillance, reconnaissance, intelligence gathering, environmental monitoring, and infrastructure monitoring.

The term “scene” means a subset of the three-dimensional real-world (i.e., 3D physical reality) as perceived through the field of view of one or more cameras or other sensors. In at least one embodiment, there may be at least 1, 2, 3, 4, 5, 10, 15, 20, 25, 30, 35 or 40, 100, 1000, or more cameras and or other sensors. In at least one embodiment, the number of cameras or other sensors may be between 2 and 4, between 4 and 8, between 8 and 16, between 16 and 40, between 40 and 100, or at least 100.

The term “object” means an element in a scene. For example, a scene may include one or more of the following objects: a person, a child, a car, a truck, a crane, a mining truck, a bus, a train, a motorcycle, a wheel, a patch of grass, a bush, a tree, a branch, a leaf, a rock, a hill, a cliff, a river, a road, a marking on the road, a depression in a road surface, a snow flake, a house, an office building, an industrial building, a tower, a bridge, an aqueduct, a bird, a flying bird, a runway, an airplane, a helicopter, door, a door knob, a shelf, a storage rack, a fork lift, a box, a building, an airfield, a town or city, a river, a mountain range, a field, a jungle, and a container. An object may be a moving element or may be stationary or substantially stationary. An object may be considered to be in a background or a foreground.

The term “physical surface” means the surface of an object in a scene that emits and/or reflects electromagnetic signals in at least one portion of the electromagnetic spectrum and where at least a portion of such signals travel across at least a portion of the scene.

The term “3D point” means a representation of the location of a point in the scene defined at least in part by at least three parameters that indicate distance in three-dimensions from an origin reference to the point, for example, in three directions from the origin where the directions may be substantially perpendicular (at least not co-planar or co-linear), or as an alternative example using a spherical coordinate system consisting of a radial distance, a polar angle, and an azimuthal angle.

The term “3D surface” means a digital representation of a physical surface to a known degree of accuracy. One example may be a list of 3D points that collectively describe a triangular mesh. Another example may be a collection of well-known geometric shapes such as cuboids, ellipsoids, spheres or cylinders that together may represent a physical surface to a required degree of precision in 3D.

The term “camera” means a device that comprises an image sensor, an optional filter array and a lens (or a plurality of lenses) that at least partially directs a potentially limited portion of incoming electromagnetic signals onto at least some of the sensor elements in an image sensor. The lens, for example, may be a pin hole, an optical lens, a diffractive grating lens or combinations thereof. In certain embodiments a camera may be an imaging device that may image from electromagnetic signals in one or more bands including for example visible, ultraviolet, infra-red, short-wave infra-red (SWIR).

The term “each” as used herein means that at least 95%, 96%, 97%, 98%, 99% or 100% of the items or functions referred to perform as indicated. Exemplary items or functions include, but are not limited to, one or more of the following: location(s), image pair(s), cell(s), pixel(s), pixel location(s), layer(s), element(s), neighbourhood(s), point(s), 3D neighbourhood(s), 3D point(s), and calibration point(s).

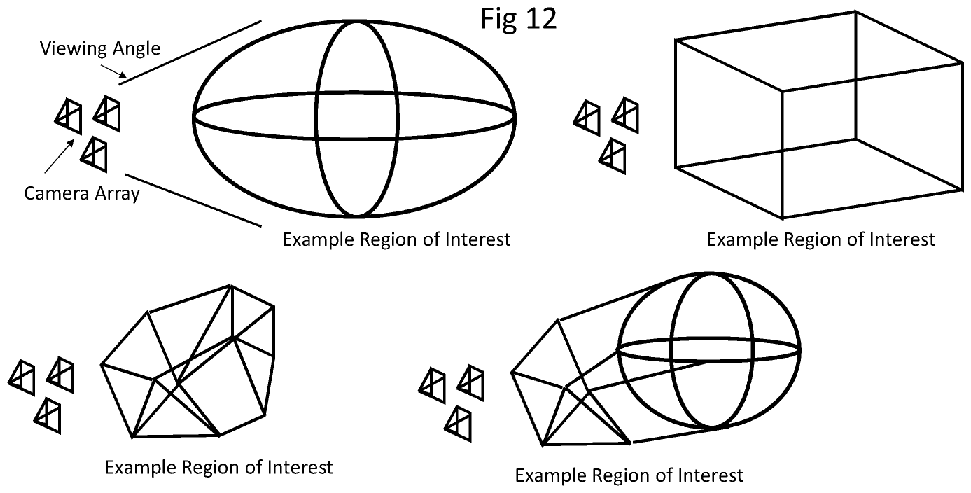

The “region of interest” as used herein means a three-dimensional region of physical space that the cameras in the camera array simultaneously view at least a substantial portion thereof and includes at least the calibration points being used to determine a calibration. Consequently, the at least a substantial portion of the region of interest is in front of the cameras in the array, and the at least a substantial portion of the region of interest is within view of at least a substantial portion of the cameras. The region of interest may be, for example, a rectangular box, a sphere, an ellipsoid, a convex hull of a set of 3D points, or a 3D region approximated to within 1% of its total volume by a union and/or intersection of a number of such shapes. Exemplary regions of interest in the view of an exemplar camera array are illustrated in FIG. 12. Other nonregular and/or regular 3D shapes that may be used to define a region of interest are contemplated. The region of interest may be symmetrical, non-symmetrical or combinations thereof.

The “total depth of the region of interest” as used herein means the physical extent of the region of interest in view of at least a portion of the cameras in the array as measured from the region's closest 3D point to at least one or more of the cameras to the region's furthest 3D point away into the scene from the at least one or more cameras in the camera array. For example, in a box-like region of interest that is 20 meters high 100 meters in depth the closest 3D point may be the 3D point in front of the camera array and the furthest 3D point away into the scene may be a diagonal of the box-like region. For example, in a spherical like region of interest that has a diameter of 100 meters the closest 3D point may be the 3D point in front of in front of the camera and the furthest 3D point away into the scene may be a 3D point diametrically opposite away into the scene. Other nonregular or regular 3D shapes may define a region of interest and may impact where in the region a measurement is taken for measuring the total depth of the region.

The term “at least a substantial portion” as used herein means that at least 40%, 50%, 60%, 70%, 80%, 85%, 95%, 96%, 97%, 98%, 99%, or 100% of the region, items or functions referred to. Exemplary items or functions include, but are not limited to, one or more of the following: location(s), image pair(s), cell(s), pixel(s), pixel location(s), layer(s), element(s), point(s), neighbourhood(s), 3D neighbourhood(s), and 3D point(s), and calibration points.

The term “pose” means the location and orientation of an object, sensor, camera, array of sensors or array of cameras. The location and orientation may be described by a set of parameters and the set of parameters used may depend on the coordinate system being used. For example, in a cartesian coordinate system the parameters may comprise six numbers, three for the location being described by X, Y, X coordinates and three for the orientation being described by rotation from the reference axis for yaw, pitch, and roll. The pose may be described by rotation and translation transformations from an origin. The rotation and translation transforms may be represented in matrix form.

The term “calibration point” is a 3D point in a scene, known to a suitable level of accuracy that is also visible in one or more camera images and so has a corresponding 2D pixel location on the one or more camera images. In at least one embodiment, the number of visible calibration points at known three-dimensional locations that are visible to one or more cameras in the camera array may be about 6, 8, 10, 12, 16, 20, 24, 30, 32, 36, 40, 50, 60, 100, 1000, or 5000. In at least one embodiment, the number of visible calibration points at known three-dimensional locations, that are visible to one or more cameras in the camera array, may be between 6 to 12, between 8 to 12, between 10 to 16, between 16 to 20, between 20 to 24, between 24 to 30, between 30 to 36, between 32 to 40, between 40 to 60, between 60 to 100, between 100 to 1000, or between 1000 to 5000.

The term “enclosing volume of 3D points” means a volume that at least contains the convex hull of the 3D points.

The term “enclosing volume of the number of visible calibration points” means at least the convex hull volume of the calibration points.

In at least one embodiment, a system for calibrating a camera comprising:
at least one camera;
wherein the camera may be configured to image a configured calibration scene and the configured scene contains a least a three-dimensional region of interest and a number of visible calibration points at known three-dimensional locations which may be arranged in the three-dimensional region of interest with a minimum separation between a substantial portion of pairs of calibration points in the three-dimensional region of at least 10% of the total depth of the region of interest and the enclosing volume of the number of visible calibration points is at least 80% of the total volume of the region of interest t;
   one or more processors that is configured to:
capture at least one image from the at least one camera and receive visible location of a number of calibration points at known three-dimensional locations; and
use the locations in the image of the visible calibration points together with their known three-dimensional locations to calculate a camera calibration.

In certain embodiments, a minimum separation between a substantial portion of pairs of calibration points in the three-dimensional region of at least about 5%, 10%, 15%, 20%, 25% or 30% of the total depth of the region of interest. In certain embodiments, a minimum separation between a substantial portion of pairs of calibration points in the three-dimensional region of between 5% to 10%, between 10% to 15%, between 15% to 20%, between 20% to 25%, between 25% to 30% of the total depth of the region of interest.

In certain embodiments, the enclosing volume of the number of visible calibration points may be at least 60%, 70%, 80%, 90%, 95%, 98%, 99%, or 100% of the total volume of the region of interest.

In certain embodiments, the enclosing volume of the number of visible calibration points may be between 60% to 70%, between 70% to 80%, between 80% to 90%, between 90% to 95%, between 95% to 98%, between 98% to 99%, 99% of the total volume of the region of interest.

In certain embodiments, a minimum separation between a substantial portion of pairs of calibration points in the three-dimensional region of at least about 5%, 10%, 15%, 20%, 25% or 30% of the total depth of the region of interest, and the enclosing volume of the number of visible calibration points may be at least 60%, 70%, 80%, 90%, 95%, 98%, 99%, or 100% of the total volume of the region of interest.

In certain embodiments, a minimum separation between a substantial portion of pairs of calibration points in the three-dimensional region of at least about 5%, 10%, 15%, 20%, 25% or 30% of the total depth of the region of interest, and the enclosing volume of the number of visible calibration points may be between 60% to 70%, between 70% to 80%, between 80% to 90%, between 90% to 95%, between 95% to 98%, between 98% to 99%, 99% of the total volume of the region of interest.

In certain embodiments, the location of the calibration point within the region of interest may be placed in one or more of the following manners: randomly, orderly, and combinations thereof, on a number of planes (horizontal, vertical, diagonal, oblique, or combinations thereof) as long as the required between minimum separation between a substantial portion of pairs of calibration points in the three-dimensional region is maintained.

### Main Flow

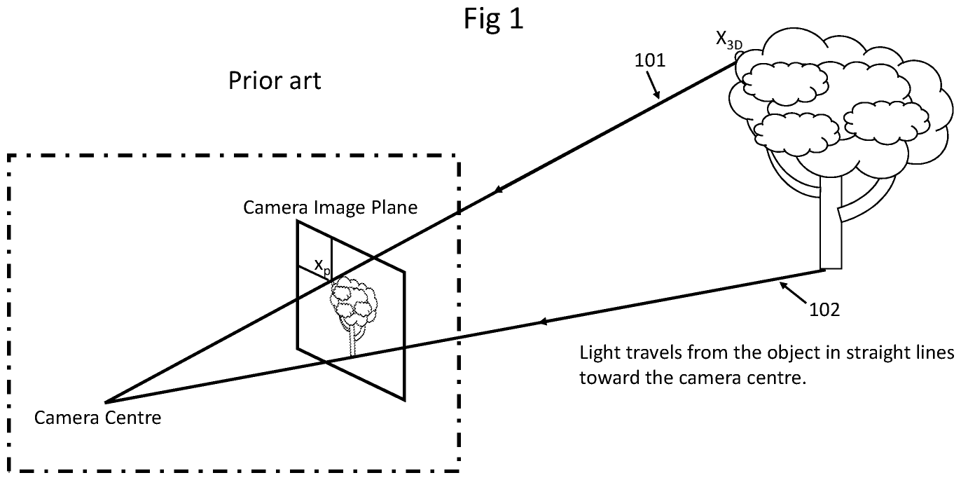

Determining accurately the calibration of even the simple camera, (e.g., for a pinhole camera), may be challenging. An illustration of the image formation process under the assumption of a prior art pinhole model is shown in FIG. 1. As shown in FIG. 1, light travels from the object, (here a tree) in straight lines (for example, along lines 101, 102, toward the camera centre and passes through the camera image plane.

The pinhole camera model is conventionally represented by a matrix (the projection matrix) that must be determined to an acceptable level of accuracy before quantitative measurements may be made with the imaging data captured by a camera's sensor.

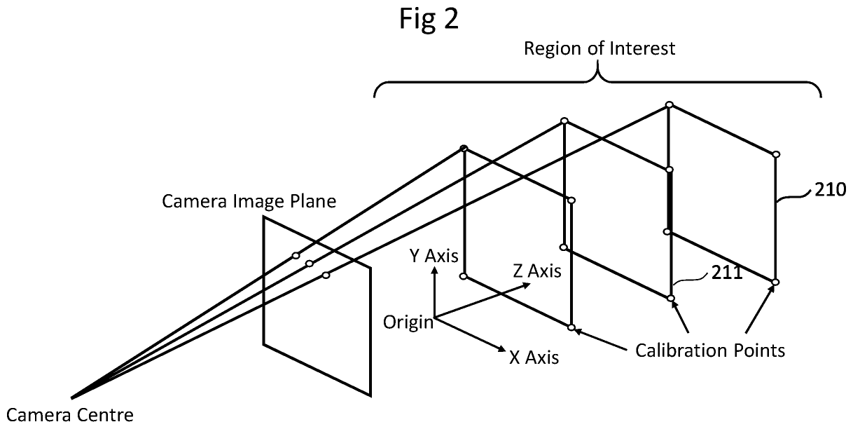

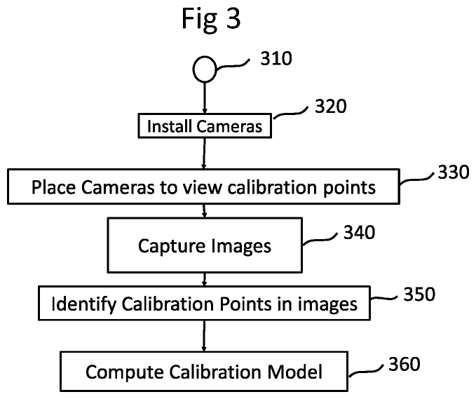

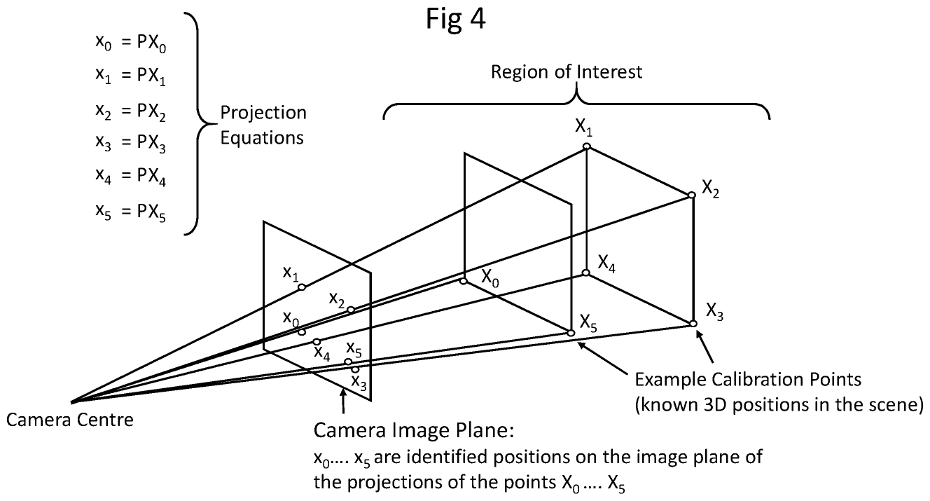

Many calibration methods start with a camera viewing a scene that has within view a number of points that are (i) in known 3D positions in the physical scene in view and (ii) identified on at least one image taken by the camera. These 3D points in the physical scene may be termed calibration points, for example as illustrated in FIGS. 2 and 4. An exemplary calibration procedure is shown in the flow diagram in FIG. 3. Starting at 310, cameras are sourced from hardware suppliers and come with a limited set of specifications that may be insufficient to allow immediate use of the cameras for a range of applications. At step 320 the sourced cameras are installed in their intended location, often rigidly mounted on walls, buildings and/or other infrastructure but also on various vehicles or other types of mobile platforms. Whether the platform is mobile or not, typically, once mounted, the camera positions relative to each other is intended to be fixed (i.e., variation of pose between cameras once mounted is often an unwanted source of perturbations that is typically minimised by employing rigid mounting positions and framework for and between the cameras). Once mounted the next step 330 may be to show the cameras a set of calibration points in the scene. If the cameras are mounted on a mobile platform or vehicle, the platform or vehicle may be moved to view the set of calibration points, if the cameras are not movable then a set of calibration points are either measured from points in the scene or items with calibration points labelled on them may be moved into camera view and their 3D position measured. At step 340 the cameras then capture one or more images of the scene with the calibration points viewable therein. The precise 2D locations of the calibration points in one or more images captured are then recorded at step 350. Finally, the known 3D positions of the calibration points together with these 2D locations in the one or more images are used, via a selected calibration algorithm (for example, the DLT method), to generate a camera calibration.

An example scene that includes some example calibration points is shown in FIG. 2. FIG. 2 illustrates four calibration points on three spaced apart planes in a region of interest. If using the pinhole camera model, determining the projection matrix (P) given both the 3D positions and 2D projections of the calibration points is the process of calibration associated with the pinhole camera model as illustrated in FIG. 4. For example, in FIG. 4 are shown the equations that link projection matrix P and the 3D positions and 2D projections of the shown calibration points. The projection matrix (P) depends on some parameters that are inbuilt into the camera unit—these are termed the intrinsic parameters. It also depends on the position and orientation (or equivalently the pose) of the camera relative to some known origin in the 3D physical world—these are termed the extrinsic parameters.

As illustrated in FIG. 4, six calibration points may be sufficient to recover the projection matrix of a camera (using the pinhole model) via the Direct Linear Transformation (DLT) method known in the art. However, due to errors both in the 3D positions in physical space, as well as errors in locating their projections in the image, it may be desirable to use more than six calibration points.

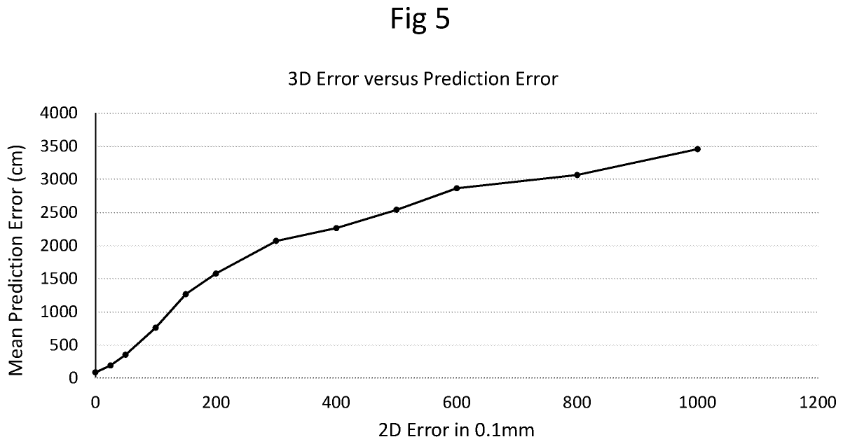

FIG. 5 shows the sensitivity of a typical DLT calibration procedure using 6 calibration points arranged in and around a 2 m volume that represents the region of interest (as shown in FIG. 2). In FIG. 5, the X axis (labelled 2D Error in 0.1 mm) represents the simulated 3D error applied to the calibration point positions (in 0.1 mm increments), and the Y axis (labelled Mean Prediction Error (CM)) the resulting error (in cm) in a standard stereo reconstruction of those 3D positions using two calibrated cameras where the locations of the calibration points' projections have been identified to within a simulated 0.1 pixel error (note 0.1 pixel error may be considered the lowest practical limit for identifying features on digital images).

It is clear from this graph that errors grow rapidly to over 30 metres when even small amounts (for example, 4 cm random positional errors in 3D) of uncertainty is present in the 3D locations and 2D projections of the calibration points. Adding more calibration points may improve this sensitivity, but equally it may be difficult and/or impractical to have too many calibration points as each must be physically placed into the calibration view and measured to an acceptable level of accuracy.

From geometrical considerations additional calibration points further away from the cameras, for example, calibration points on planes 211 and 210 in FIG. 2, may constrain the potential solutions and therefore be less sensitive to measurement errors.

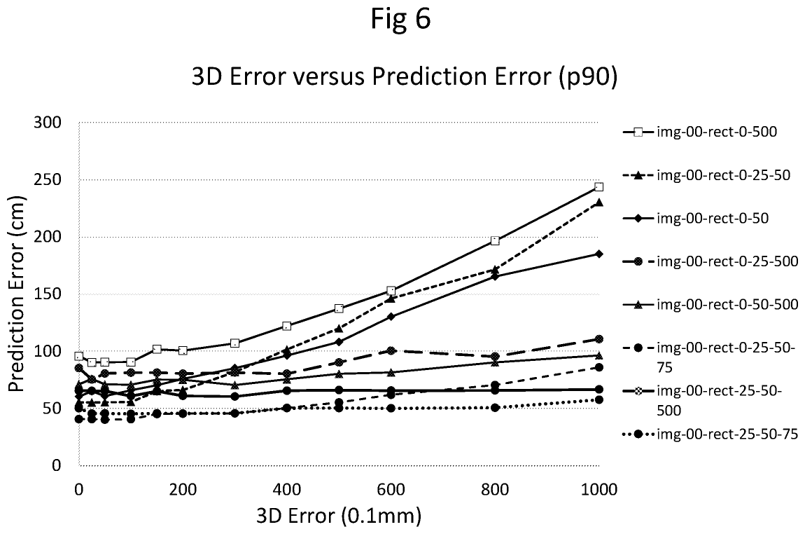

FIG. 6 shows the results of using sets of 4 calibration points arranged on at the corners of a rectangular shape on vertical planes at different depths in the scene (i.e., calibration points as shown in FIG. 2). In FIG. 6 the X axis is the same as in FIG. 5, while the Y axis (representing reconstruction error and labelled Prediction Error (cm)) shows errors at least 10 times lower than those from using just the basic six calibration points shown in FIG. 5. The key on the right details the type of calibration points used in some of the experiments run—the trailing numbers after the word “rect” list the depth spacing of the vertical planes on which the calibration points are placed in the region of interest. For example, the worst error is for “img-00-rect-0-500” which indicates a rectangle of 4 calibration points on 2 planes, one at Z=0 m and another at Z=500 m respectively. In contrast, in this example, the best performing arrangements was for calibration planes that include a selection of the 25 m, 50 m and 75 m options. Those that include a 500 m option do not improve as well as those with one or more of the closer options. The following table 1 shows the full data used to create FIG. 6 which for clarity only FIG. 6 shows a selection of the table in graphical form.

TABLE 1
Introduced 3D Noise added to Calibration Points (units of 0.1 mm)

| Calibration Point Arrangement | 0 | 25 | 50 | 100 | 150 | 200 | 300 | 400 | 500 | 600 | 800 | 1000 |
|---|---|---|---|---|---|---|---|---|---|---|---|---|
| img-00-rect-0-25 | 65.18 | 65.89 | 71.14 | 95.99 | 121.35 | 156.72 | 225.47 | 295.13 | 345.93 | 423.02 | 572.04 | 696.43 |
| img-00-rect-0-500 | 95.70 | 90.24 | 90.43 | 90.46 | 101.75 | 100.55 | 106.95 | 122.09 | 137.20 | 152.72 | 196.53 | 243.55 |
| img-00-rect-0-25-50 | 55.29 | 55.21 | 55.39 | 55.57 | 65.13 | 66.16 | 81.89 | 101.50 | 120.03 | 146.05 | 171.52 | 230.28 |
| img-00-rect-0-50 | 60.34 | 65.08 | 60.69 | 65.79 | 70.22 | 75.86 | 85.20 | 96.16 | 108.04 | 130.18 | 165.27 | 185.03 |
| img-00-rect-0-25-500 | 85.33 | 75.28 | 80.54 | 81.24 | 81.28 | 80.39 | 81.33 | 80.28 | 90.19 | 100.50 | 95.34 | 110.59 |
| img-00-rect-0-50-500 | 71.07 | 75.84 | 70.96 | 70.73 | 75.24 | 75.03 | 70.42 | 75.47 | 80.26 | 81.39 | 90.17 | 96.35 |
| img-00-rect-0-25-50-75 | 40.58 | 40.64 | 40.19 | 40.55 | 45.12 | 45.35 | 45.66 | 50.40 | 55.23 | 61.88 | 70.39 | 85.93 |
| img-00-rect-0-75 | 55.40 | 50.80 | 55.29 | 55.34 | 55.47 | 55.21 | 55.64 | 56.82 | 60.85 | 67.08 | 76.98 | 85.35 |
| img-00-rect-25-500 | 75.20 | 70.57 | 71.02 | 70.32 | 75.30 | 75.19 | 71.38 | 75.32 | 75.09 | 75.57 | 76.26 | 80.36 |
| img-00-rect-0-25-75 | 50.06 | 50.04 | 50.08 | 45.73 | 50.25 | 50.13 | 55.05 | 55.68 | 56.39 | 65.25 | 72.08 | 80.32 |
| img-00-rect-25-50-500 | 65.50 | 65.35 | 65.26 | 60.82 | 65.06 | 60.96 | 60.40 | 65.45 | 65.99 | 65.54 | 65.74 | 66.58 |
| img-00-rect-25-75 | 55.28 | 55.22 | 55.10 | 50.80 | 55.25 | 55.51 | 56.29 | 55.30 | 55.04 | 55.38 | 55.79 | 60.09 |
| img-00-rect-25-50-75 | 50.11 | 45.55 | 45.64 | 45.23 | 45.69 | 45.53 | 45.69 | 50.23 | 50.27 | 50.08 | 50.59 | 57.53 |

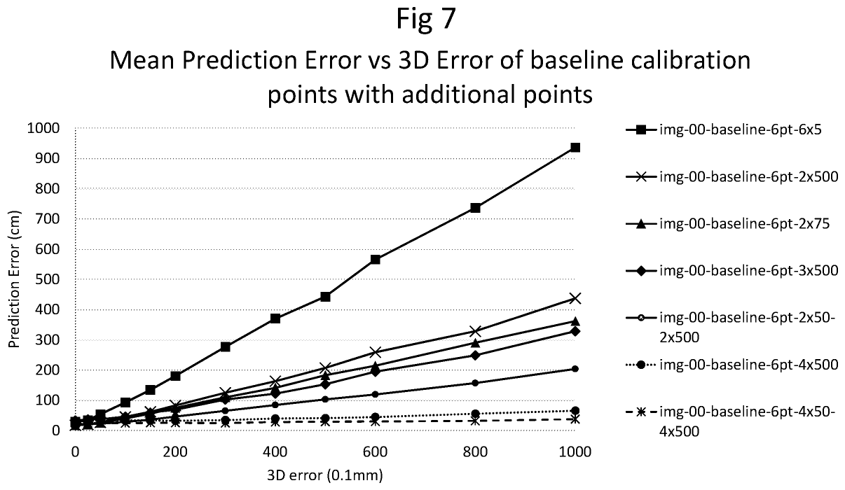

The value of calibration points at the 50 m or 75 m distances in improving calibration performance is shown in FIG. 7. The x-axis is the 3D error (0.1 mm) and the y-axis is the 3D reconstruction error (cm). FIG. 7 shows the performance of the original six calibration points close to the cameras, and the performance when these six calibration points are enhanced with 2 or 4 extra calibration points at one additional plane some metres further away (5 m, 50 m, 75 m, 500 m). In this example, the graph shows how various combinations of calibration points at some distance results in at least a factor of 2 reduction in error, but the best is when 4 calibration points (the corners of a vertically arranged rectangle in the view) are included at 500 m. The following Table 2 shows the full data used to create FIG. 7, which for clarity only shows an illustrative subset of the data.

TABLE 2
Introduced 3D Noise added to Calibration Points (units of 0.1mm)

| Calibration Point Arrangement | 0 | 25 | 50 | 100 | 150 | 200 |
|---|---|---|---|---|---|---|
| img-00-baseline-6pt | 87.51 | 192.21 | 351.91 | 761.32 | 1267.18 | 1578.86 |
| img-00-baseline-6pt-6x5 | 29.23 | 34.13 | 54.35 | 93.19 | 134.94 | 180.67 |
| img-00-baseline-6pt-2x500 | 17.96 | 20.90 | 27.27 | 45.68 | 62.07 | 83.12 |
| img-00-baseline-6pt-2x25 | 18.74 | 21.22 | 27.80 | 42.49 | 62.24 | 77.80 |
| img-00-baseline-6pt-2x75 | 17.07 | 19.90 | 25.52 | 40.37 | 56.07 | 75.26 |
| img-00-baseline-6pt-3x500 | 33.84 | 36.99 | 37.27 | 46.55 | 59.72 | 68.73 |
| img-00-baseline-6pt-2x50 | 17.51 | 19.34 | 24.22 | 36.63 | 52.71 | 69.67 |
| img-00-baseline-6pt-2x50-2x500 | 20.52 | 21.36 | 22.68 | 28.91 | 36.18 | 46.66 |
| img-00-baseline-6pt-6x50 | 17.91 | 18.38 | 19.16 | 21.34 | 23.25 | 26.94 |
| img-00-baseline-6pt-4x50 | 19.77 | 19.15 | 19.54 | 20.95 | 22.11 | 24.57 |
| img-00-baseline-6pt-4x500 | 32.00 | 33.82 | 32.08 | 34.42 | 33.33 | 32.85 |
| img-00-baseline-6pt-6x500 | 29.82 | 31.45 | 32.40 | 32.13 | 32.79 | 34.20 |
| img-00-baseline-6pt-5x500 | 31.74 | 30.90 | 31.27 | 32.11 | 35.68 | 33.14 |
| img-00-baseline-6pt-4x50-4x500 | 25.14 | 24.68 | 24.74 | 24.67 | 25.80 | 25.67 |
| img-00-baseline-6pt-4x75 | 18.52 | 18.23 | 18.83 | 18.63 | 19.64 | 19.36 |
| img-00-baseline-6pt-2x2M | 15.77 | 17.52 | 23.54 | 36.58 | 50.89 | 62.96 |
| img-00-baseline-6pt-3x2M | 19.23 | 20.12 | 21.90 | 26.94 | 35.14 | 43.54 |
| img-00-baseline-6pt-4x2M | 28.59 | 29.44 | 28.70 | 29.13 | 30.82 | 31.79 |
| img-00-baseline-6pt-4xinf | 13.48 | 15.23 | 18.12 | 26.95 | 37.20 | 48.61 |
| img-00-baseline-6pt-5x2M | 778181.98 | 796165.90 | 778692.65 | 787649.57 | 793649.82 | 763338.18 |
| img-00-baseline-6pt-6x2M | 1584941.75 | 1580718.56 | 1575130.08 | 1584011.67 | 1558361.67 | 1587664.14 |
| img-00-baseline-6pt-6xinf | 13.00 | 13.90 | 16.71 | 26.44 | 37.04 | 46.10 |
| Calibration Point Arrangement | 300 | 400 | 500 | 600 | 800 | 1000 |
| img-00-baseline-6pt | 2070.39 | 2264.10 | 2540.23 | 2865.87 | 3065.08 | 3455.92 |
| img-00-baseline-6pt-6x5 | 277.05 | 370.65 | 443.11 | 565.90 | 736.50 | 936.49 |
| img-00-baseline-6pt-2x500 | 125.49 | 163.42 | 207.11 | 258.97 | 328.64 | 437.39 |
| img-00-baseline-6pt-2x25 | 121.51 | 151.00 | 179.88 | 219.94 | 301.93 | 378.27 |
| img-00-baseline-6pt-2x75 | 109.83 | 141.80 | 182.97 | 214.67 | 290.50 | 362.00 |
| img-00-baseline-6pt-3x500 | 102.59 | 122.55 | 153.35 | 194.77 | 249.12 | 329.04 |
| img-00-baseline-6pt-2x50 | 99.90 | 134.81 | 165.62 | 198.03 | 255.24 | 326.83 |
| img-00-baseline-6pt-2x50-2x500 | 65.53 | 84.90 | 103.16 | 119.86 | 157.12 | 204.24 |
| img-00-baseline-6pt-6x50 | 35.59 | 43.68 | 52.88 | 61.57 | 80.84 | 97.79 |
| img-00-baseline-6pt-4x50 | 28.87 | 33.54 | 42.61 | 46.83 | 60.81 | 77.41 |
| img-00-baseline-6pt-4x500 | 34.95 | 40.27 | 41.43 | 44.97 | 55.88 | 65.83 |
| img-00-baseline-6pt-6x500 | 36.96 | 38.41 | 41.18 | 44.97 | 52.69 | 63.73 |
| img-00-baseline-6pt-5x500 | 38.35 | 39.06 | 42.77 | 47.13 | 54.01 | 62.14 |
| img-00-baseline-6pt-4x50-4x500 | 25.39 | 28.57 | 29.87 | 30.07 | 32.34 | 37.91 |
| img-00-baseline-6pt-4x75 | 20.69 | 23.07 | 24.22 | 26.39 | 30.97 | 35.11 |
| img-00-baseline-6pt-2x2M | 95.85 | 124.58 | 159.18 | 193.61 | 251.72 | 313.40 |
| img-00-baseline-6pt-3x2M | 60.18 | 77.44 | 94.86 | 112.98 | 145.42 | 182.95 |
| img-00-baseline-6pt-4x2M | 35.46 | 38.01 | 43.08 | 50.80 | 58.49 | 66.74 |
| img-00-baseline-6pt-4xinf | 69.31 | 93.68 | 118.76 | 139.39 | 186.70 | 225.37 |
| img-00-baseline-6pt-5x2M | 774724.72 | 761606.09 | 783669.52 | 778218.14 | 774717.35 | 775744.11 |
| img-00-baseline-6pt-6x2M | 1612744.21 | 1577509.60 | 1585252.83 | 1582296.21 | 1563330.31 | 1571665.44 |
| img-00-baseline-6pt-6xinf | 68.76 | 96.02 | 115.47 | 140.00 | 185.84 | 237.77 |

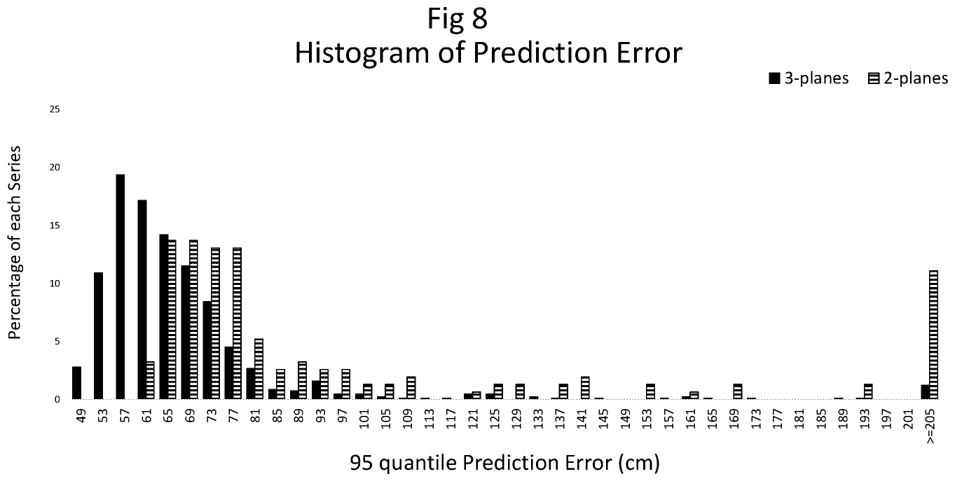

FIG. 8 shows the errors of various arrangements of 2 and 3 plane calibration arrangements; the X axis (labelled 95 quantile Reconstruction Error (cm)) is the reprojection error achieved with an arrangement, and the Y axis (labelled Percentage of each Series) the number of arrangements (as a fraction of the total number of experiments) achieving the associated error. Arrangements with 3 planes are clearly better than those with just 2 planes, i.e., three planes consistently result in less reconstruction error than arrangements with just two planes.

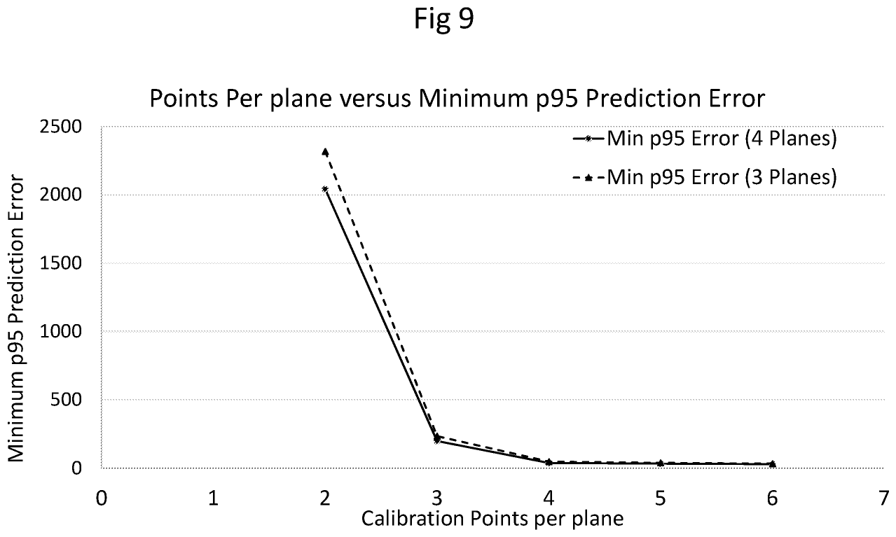

FIG. 9 shows the results of varying the number of calibration points per plane. In FIG. 2, calibration points in a rectangle on each plane is shown as an example, resulting in 4 calibration points per plane. For the results in FIG. 9, multiple planes each with a varying number (2 to 6) of non co-linear calibration points on each plane are tested. The results reveal a limiting behaviour; the errors reduce up to having 4 calibration points on each plane, but thereafter no further significant error reduction is achieved by adding more calibration points.

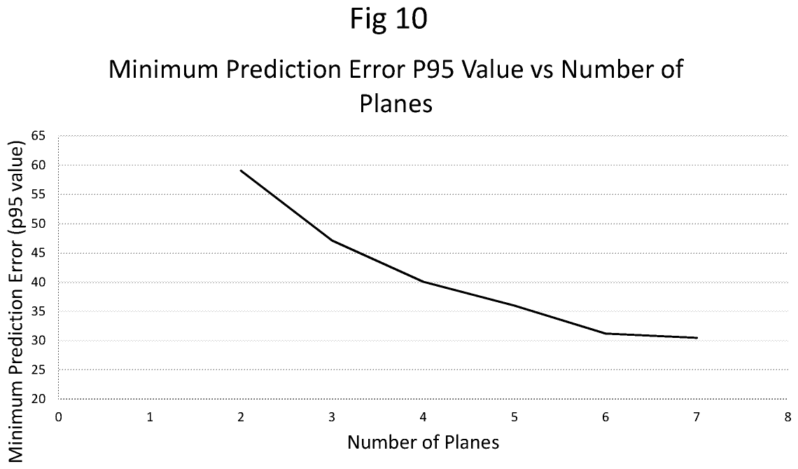

Now using just 4 calibration points per plane, FIG. 10 shows the effect of using more than just 3 planes within the region of interest. This shows a gradual limiting behaviour as the number of planes is increase from 2 to 7, with the relative benefit of adding more planes tailing off. These results show how a set of 3 to 7 vertical planes with only 4 calibration points at the corners of a rectangular shape on each, arranged at various spacings that span substantial portion (for example, 80%, 85%, 90%, 95%, or 100% of the region of interest in front of the cameras), may be sufficient to enable an accurate calibration via a DLT method, as FIG. 10 shows clearly how accuracy levels off after 7 planes.

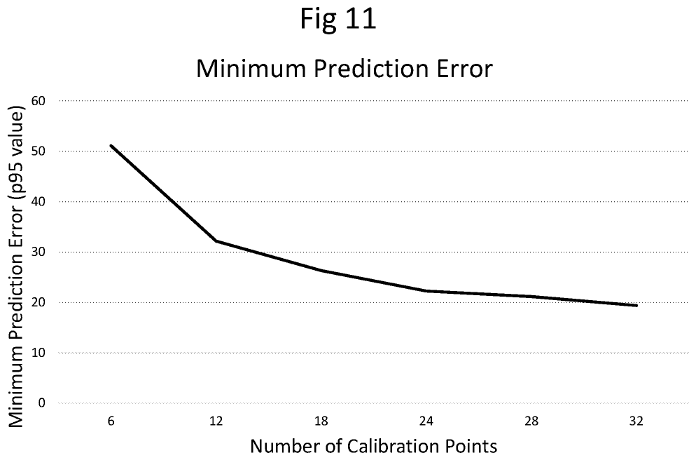

Another test was conducted to address how sensitive the accuracy of the results are with respect to the precise calibration point positions, using at least one embodiment. An experiment to choose 3D calibration points randomly distributed throughout the region of interest in the scene was performed. As disclosed herein, the spacing of the calibration points (in 3D) may be relevant, and also that more than the theoretical minimum of six calibration points may be beneficial but that this benefit tails off after a total of approximately 24 calibration points (i.e., 4 calibration points on each of 6 planes as outlined above). FIG. 11 shows the results of various numbers of calibration points randomly positioned in the scene in such a way that no two calibration points are closer than 10% of the depth of the region of interest. For example, when the depth of the region of interest is 0-100 m in front of the cameras, this constraint means the calibration points are at least 10 m away from each other.

These results show again how the accuracy rapidly improves as more calibration points are added up to having 24 calibration points, but that the benefit tails off quickly beyond that. This result demonstrates two surprising facts; (1) that although six calibration points are the theoretical minimum required to compute camera calibration, the results obtained may be improved by adding even a few more calibration points, and (2) over 80% of the accuracy improvement made possible by adding more calibration points is achieved by choosing just 24 calibration points. Equally, FIG. 11 shows that 95% of this benefit is achieved by using just 32 calibration points.

In addition to other advantages disclosed herein, one or more of the following advantages may be present in certain exemplary embodiments:

One advantage may be that a set of calibration points may be defined that provides a balance between sensitivity to errors, while at the same time being not too burdensome to physically construct and measure in preparation for the camera to view the scene.

Another advantage may be that, via analyses similar to those disclosed herein, different camera calibration arrangements may be designed to suit certain applications of some cameras or camera arrays. An application where objects in the scene are typically very small and close to the cameras will have different calibration requirements than an application where the objects are typically large or far away from the cameras.

Another advantage may be that using a constructed calibration process as disclosed herein means that calibration may be computed using one single image followed by a simple computational procedure that may be completed in real-time or in substantially real-time.

The calibrations embodiments disclosed herein may be more convenient and therefore cost effective compared to other processes that may involve more infrastructure, more procedures and therefore time to complete.

Further advantages and/or features of the claimed subject matter will become apparent from the following examples describing certain embodiments of the claimed subject matter.
1. A system for calibrating a camera comprising:
   at least one camera;
   wherein the camera is configured to image a configured calibration scene and the configured scene contains a least a three-dimensional region of interest and a number of visible calibration points at known three-dimensional locations which are arranged in the three-dimensional region of interest with a minimum separation between a substantial portion of pairs of calibration points in the three-dimensional region of at least 10% of the total depth of the region of interest and the enclosing volume of the number of visible calibration points is at least 80% of the total volume of the region of interest;
   one or more processors that is configured to:
   capture at least one image from the at least one camera and receive visible location of a number of calibration points at known three-dimensional locations; and
   use the locations in the image of the visible calibration points together with their known three-dimensional locations to calculate a camera calibration.
2. The system of example 1, wherein the calibration scene consists of at least 4 or 6 calibration points substantially arranged as the corners of a cubic shape that is contained within the region of interest in front of the at least one camera.
3. The system of example 1, wherein the calibration scene consists of at least 4 or 6 calibration points substantially arranged as the corners of a rectangular shape that is contained within region of interest in front of the at least one camera.
4. The system of any of examples 1 to 3, wherein at least one plane, on which the at least 4 or 6 calibration points are located, is located within the furthest 25% or 50% of the region of interest away from the at least one camera.
5. The system of any of examples 1 to 4, wherein the at least one plane, on which the at least 4 or 6 calibration points are located, is located within the most central 25% or 50% of the region of interest from the at least one camera.
6. The system of any of examples 1 to 5, wherein there are at least 3 planes, each or at least a substantial portion of the at least 3 planes, has at least 4 or 6 calibration points, the location of the at least 3 planes separated substantially evenly over the region of interest away from the at least one camera.
7. The system of any of examples 1 to 6, wherein the at least 4 or 6 calibration points on one or more planes in front of the camera are spaced sufficiently to the left, right, top and bottom of the three-dimensional physical calibration space so that the at least one camera and an object the at least one camera is mounted on is moved through the region of interest through the at least 4 or 6 calibration points on one or more planes without disturbing the at least 4 or 6 calibration points.
8. The system of any of examples 1 to 7, wherein there are at least 6 planes, each or at least a substantial portion have at least 4 or 6 calibration points.
9. The system of any of examples 1 to 8, wherein the region of interest is a rectangular box, a sphere, an ellipsoid, a convex hull of a set of 3D points, or a 3D region approximated to within 1% of its total volume by one or more of the following: a union, intersection of a number of such shapes, and combinations thereof.
10. The system of any of examples 1 to 9, wherein the region of interest is symmetrical, non-symmetrical or combinations thereof.
11. The system of any of examples 1 to 9, wherein the total depth region of interest is the physical extent of the region in view of at least a portion of the cameras in the array as measured from the region's closest point to at least one or more of the cameras to the region's furthest point away into the scene from the at least one or more cameras in the camera array.
12. The system of any of examples 1 to 10, wherein the number of visible calibration points at known three-dimensional locations that are visible to one or more cameras in the camera array is e between 6 to 12, between 8 to 12, between 10 to 16, between 16 to 20, between 20 to 24, between 24 to 30, between 30 to 36, between 32 to 40, between 40 to 60, between 60 to 100, between 100 to 1000, or between 1000 to 5000.
13. The system of any of examples 1 to 12, wherein the minimum separation between a substantial portion of pairs of calibration points in the three-dimensional region of between 5% to 10%, between 10% to 15%, between 15% to 20%, between 20% to 25%, between 25% to 30% of the total depth of the region of interest.
14. The system of any of examples 1 to 12, wherein the enclosing volume of the number of visible calibration points is between 60% to 70%, between 70% to 80%, between 80% to 90%, between 90% to 95%, between 95% to 98%, between 98% to 99%, 99% of the total volume of the region of interest.
15. The system of any of examples 1 to 13, wherein the location of the calibration points within the region of interest is placed in one or more of the following: an ordered manner, a random manner, and combinations thereof, as long as the required between minimum separation between a substantial portion of pairs of calibration points in the three-dimensional region is maintained.
16. The system of any of examples 1 to 15, wherein the minimum separation between the substantial portion of pairs of calibration points in the three-dimensional region of at least about 5%, 10%, 15%, 20%, 25% or 30% of the total depth of the region of interest, and the enclosing volume of the number of visible calibration points is between 60% to 70%, between 70% to 80%, between 80% to 90%, between 90% to 95%, between 95% to 98%, between 98% to 99%, 99% of the total volume of the region of interest.
17. A method for calibrating a camera comprising:
   configuring a calibration scene, wherein the configured scene contains a least a three-dimensional region of interest and a number of visible calibration points, visible to that at least one camera, at known three-dimensional locations which are arranged in the three-dimensional region of interest with a minimum separation between a substantial portion of pairs of calibration points in the three-dimensional region of at least 10% of the total depth of the region of interest;
   placing at least one camera to view the calibration scene, wherein the camera is configured to image the number of visible calibration points;
   taking an image of the number of the number of visible calibration points;
   transferring the image to the one or more processes; and
      using the one or more processors to determine the locations in the image of the visible calibration points together with their known three-dimensional locations to calculate a camera calibration.
18. The method of example 17, wherein the calibration scene consists of at least 4 or 6 calibration points substantially arranged as the corners of a cubic shape that is contained within the region of interest in front of the at least one camera.
19. The method of example 17, wherein the calibration scene consists of at least 4 or 6 calibration points substantially arranged as the corners of a rectangular shape that is contained within region of interest in front of the at least one camera.
20. The method of any of examples 17 to 19, wherein at least one plane, on which the at least 4 or 6 calibration points are located, is located within the furthest 25% or 50% of the region of interest away from the at least one camera.
21. The method of any of examples 17 to 20, wherein the at least one plane, on which the at least 4 or 6 calibration points are located, is located within the most central 25% or 50% of the region of interest from the at least one camera.
22. The method of any of examples 17 to 21, wherein there are at least 3 planes, each or at least a substantial portion of the at least 3 planes, has at least 4 or 6 calibration points, the location of the at least 3 planes separated substantially evenly over the region of interest away from the at least one camera.
23. The method of any of examples 17 to 22, wherein the at least 4 or 6 calibration points on one or more planes in front of the camera are spaced sufficiently to the left, right, top and bottom of the three-dimensional physical calibration space so that the at least one camera and an object the at least one camera is mounted on is moved through the region of interest through the at least 4 or 6 calibration points on one or more planes without disturbing the at least 4 or 6 calibration points.
24. The method of any of examples 17 to 23, wherein there are at least 6 planes, each or at least a substantial portion have at least 4 or 6 calibration points.
25. The method of any of examples 17 to 24, wherein the region of interest is a rectangular box, a sphere, an ellipsoid, a convex hull of a set of 3D points, or a 3D region approximated to within 1% of its total volume by one or more of the following: a union, intersection of a number of such shapes, and combinations thereof.
26. The method of any of examples 17 to 25, wherein the region of interest is symmetrical, non-symmetrical or combinations thereof.
27. The method of any of examples 71 to 26, wherein the total depth region of interest is the physical extent of the region in view of at least a portion of the cameras in the array as measured from the region's closest point to at least one or more of the cameras to the region's furthest point away into the scene from the at least one or more cameras in the camera array.
28. The method of any of examples 17 to 27, wherein the number of visible calibration points at known three-dimensional locations that are visible to one or more cameras in the camera array is e between 6 to 12, between 8 to 12, between 10 to 16, between 16 to 20, between 20 to 24, between 24 to 30, between 30 to 36, between 32 to 40, between 40 to 60, between 60 to 100, between 100 to 1000, or between 1000 to 5000.
29. The method of any of examples 17 to 28, wherein the minimum separation between a substantial portion of pairs of calibration points in the three-dimensional region of between 5% to 10%, between 10% to 15%, between 15% to 20%, between 20% to 25%, between 25% to 30% of the total depth of the region of interest.
30. The method of any of examples 17 to 29, wherein the enclosing volume of the number of visible calibration points is between 60% to 70%, between 70% to 80%, between 80% to 90%, between 90% to 95%, between 95% to 98%, between 98% to 99%, 99% of the total volume of the region of interest.
31. The method of any of examples 17 to 31, wherein the location of the calibration points within the region of interest is placed in one or more of the following: an ordered manner, a random manner, and combinations thereof, as long as the required between minimum separation between a substantial portion of pairs of calibration points in the three-dimensional region is maintained.
32. The method of any of examples 17 to 31, wherein the minimum separation between the substantial portion of pairs of calibration points in the three-dimensional region of at least about 5%, 10%, 15%, 20%, 25% or 30% of the total depth of the region of interest, and the enclosing volume of the number of visible calibration points is between 60% to 70%, between 70% to 80%, between 80% to 90%, between 90% to 95%, between 95% to 98%, between 98% to 99%, 99% of the total volume of the region of interest.
33. The method for calibrating a camera using any of the systems in examples 1 to 16.
34. One or more computer-readable non-transitory storage media embodying software that is operable when executed using any of the systems or methods in examples 1 to 32.

Any description of prior art documents herein, or statements herein derived from or based on those documents, is not an admission that the documents or derived statements are part of the common general knowledge of the relevant art.

While certain embodiments have been shown and described herein, it will be obvious to those skilled in the art that such embodiments are provided by way of example only.

In the foregoing description of certain embodiments, specific terminology has been resorted to for the sake of clarity. However, the disclosure is not intended to be limited to the specific terms so selected, and it is to be understood that a specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It is to be understood that the present disclosure is not limited to the disclosed embodiments, and is intended to cover various modifications and equivalent arrangements included within the spirit and scope of the present disclosure. Also, the various embodiments described above may be implemented in conjunction with other embodiments, e.g., aspects of one embodiment may be combined with aspects of another embodiment to realize yet other embodiments. Further, independent features of a given embodiment may constitute an additional embodiment. In addition, a single feature or combination of features in certain of the embodiments may constitute additional embodiments. Specific structural and functional details disclosed herein are not to be interpreted as limiting, but merely as a representative basis for teaching one skilled in the art to variously employ the disclosed embodiments and variations of those embodiments.

1. A system for calibrating a camera comprising:
at least one camera;
wherein the camera is configured to image a configured calibration scene and the configured scene contains a least a three-dimensional region of interest and a number of visible calibration points at known three-dimensional locations which are arranged in the three-dimensional region of interest with a minimum separation between a substantial portion of pairs of calibration points in the three-dimensional region of at least 10% of the total depth of the region of interest, and the enclosing volume of the number of visible calibration points is at least 80% of the total volume of the region of interest;
one or more processors that is configured to:
capture at least one image from the at least one camera and receive visible location of a number of calibration points at known three-dimensional locations; and
use the locations in the image of the visible calibration points together with their known three-dimensional locations to calculate a camera calibration.

2. The system of claim 1, wherein the calibration scene consists of at least 4 or 6 calibration points substantially arranged as the corners of a cubic shape or a rectangular shape that is contained within the region of interest in front of the at least one camera.

3. (canceled)

4. The system of claim 1, wherein at least one plane, on which the at least 4 or 6 calibration points are located, is located within the furthest 25% or 50% portion of the region of interest away from the at least one camera.

5. The system of claim 1, wherein the at least one plane, on which the at least 4 or 6 calibration points are located, is located within the most central 25% or 50% portion of the region of interest from the at least one camera.

6. The system of claim 1, wherein there are at least 3 planes, each or at least a substantial portion of the at least 3 planes, has at least 4 or 6 calibration points, the location of the at least 3 planes separated substantially evenly over the region of interest away from the at least one camera.

7. (canceled)

8. The system of claim 1, wherein there are at least 6 planes, each or at least a substantial portion, have at least 4 or 6 calibration points.

9. The system of claim 1, wherein the region of interest is a rectangular box, a sphere, an ellipsoid, a convex hull of a set of 3D points, or a 3D region approximated to within 1% of its total volume by one or more of the following: a union, intersection of a number of such shapes, and combinations thereof.

10. The system of claim 1, wherein the region of interest is symmetrical, non-symmetrical or combinations thereof.

11. (canceled)

12. The system of claim 1, wherein the number of visible calibration points at known three-dimensional locations that are visible to one or more cameras in a camera array is between 6 to 12, between 8 to 12, between 10 to 16, between 16 to 20, between 20 to 24, between 24 to 30, between 30 to 36, between 32 to 40, between 40 to 60, between 60 to 100, between 100 to 1000, or between 1000 to 5000.

13. The system of claim 1, wherein the minimum separation between a substantial portion of pairs of calibration points in the three-dimensional region is between 5% to 10%, between 10% to 15%, between 15% to 20%, between 20% to 25%, or between 25% to 30% of the total depth of the region of interest.

14. The system of claim 1, wherein the enclosing volume of the number of visible calibration points is between 60% to 70%, between 70% to 80%, between 80% to 90%, between 90% to 95%, between 95% to 98%, or between 98% to 99%, 99% of the total volume of the region of interest.

15. (canceled)

16. The system of claim 1, wherein the minimum separation between the substantial portion of pairs of calibration points in the three-dimensional region is at least about 5%, 10%, 15%, 20%, 25% or 30% of the total depth of the region of interest, and the enclosing volume of the number of visible calibration points is between 60% to 70%, between 70% to 80%, between 80% to 90%, between 90% to 95%, between 95% to 98%, or between 98% to 99%, 99% of the total volume of the region of interest.

17. A method for calibrating a camera comprising:
configuring a calibration scene, wherein the configured scene contains a least a three-dimensional region of interest and a number of visible calibration points, visible to that at least one camera, at known three-dimensional locations which are arranged in the three-dimensional region of interest with a minimum separation between a substantial portion of pairs of calibration points in the three-dimensional region of at least 10% of the total depth of the region of interest;
placing at least one camera to view the calibration scene, wherein the camera is configured to image the number of visible calibration points;
taking an image of the number of the number of visible calibration points;
transferring the image to the one or more processes; and
using the one or more processors to determine the locations in the image of the visible calibration points together with their known three-dimensional locations to calculate a camera calibration.

18. The method of claim 17, wherein the calibration scene consists of at least 4 or 6 calibration points substantially arranged as the corners of a cubic shape or a rectangular shape that is contained within the region of interest in front of the at least one camera.

19. (canceled)

20. The method of claim 17, wherein at least one plane, on which the at least 4 or 6 calibration points are located, is located within the furthest 25% or 50% of the region of interest away from the at least one camera.

21. The method of claim 17, wherein the at least one plane, on which the at least 4 or 6 calibration points are located, is located within the most central 25% or 50% of the region of interest from the at least one camera.

22. The method of claim 17, wherein there are at least 3 planes, each or at least a substantial portion of the at least 3 planes, has at least 4 or 6 calibration points, the location of the at least 3 planes separated substantially evenly over the region of interest away from the at least one camera.

23. (canceled)

24. The method of claim 17, wherein there are at least 6 planes, each or at least a substantial portion have at least 4 or 6 calibration points.

25. The method of claim 17, wherein the region of interest is a rectangular box, a sphere, an ellipsoid, a convex hull of a set of 3D points, or a 3D region approximated to within 1% of its total volume by one or more of the following: a union, intersection of a number of such shapes, and combinations thereof.

26. The method of claim 17, wherein the region of interest is symmetrical, non-symmetrical or combinations thereof.

27. (canceled)

28. The method of claim 14, wherein the number of visible calibration points at known three-dimensional locations that are visible to one or more cameras in a camera array is between 6 to 12, between 8 to 12, between 10 to 16, between 16 to 20, between 20 to 24, between 24 to 30, between 30 to 36, between 32 to 40, between 40 to 60, between 60 to 100, between 100 to 1000, or between 1000 to 5000.

29. The method of claim 14, wherein the minimum separation between a substantial portion of pairs of calibration points in the three-dimensional region is between 5% to 10%, between 10% to 15%, between 15% to 20%, between 20% to 25%, or between 25% to 30% of the total depth of the region of interest.

30. The method of claim 14, wherein the enclosing volume of the number of visible calibration points is between 60% to 70%, between 70% to 80%, between 80% to 90%, between 90% to 95%, between 95% to 98%, or between 98% to 99%, 99% of the total volume of the region of interest.

31. (canceled)

32. The method of claim 14, wherein the minimum separation between the substantial portion of pairs of calibration points in the three-dimensional region of at least about 5%, 10%, 15%, 20%, 25% or 30% of the total depth of the region of interest, and the enclosing volume of the number of visible calibration points is between 60% to 70%, between 70% to 80%, between 80% to 90%, between 90% to 95%, between 95% to 98%, or between 98% to 99%, 99% of the total volume of the region of interest.

33. (canceled)

34. One or more computer-readable non-transitory storage media embodying software that, when executed by a processor, cause the processor to perform the method of claim 17.
